(19) United States
(12) Patent Application Publication
(10) Pub. No.: US 2024/0070768 A1
(43) Pub. Date: Feb. 29, 2024

(54) BIDDER BUYER POOL SYSTEM

(71) Applicant: Tractus IP bb Pool LLC, Sheridan, WY (US)

(72) Inventor: Peter Grisham, Ingleside, IL (US)

(21) Appl. No.: 17/895,132

(22) Filed: Aug. 25, 2022

(51) Int. Cl. G06Q 30/08; G06Q 30/06; H04L 9/00

(52) U.S. Cl. CPC G06Q 30/08; G06Q 30/0611; G06Q 30/0619; H04L 9/50; G06Q 2220/165

(57) ABSTRACT

A bidder buyers pool to reward bidders and owners of digital or physical assets in perpetuity through the blockchain is disclosed. A smart contract is created that takes a percentage of an auction sale price and splits that up among the bidders of an item, whether it be digital or physical. The split is determined by an algorithm that rewards bidders for higher bids. A method for conducting a transaction between an asset seller, an asset creator and one or more asset buyers is disclosed to accomplish this. The method includes providing a marketplace for the transaction to be conducted; listing on a marketplace, by the asset seller, an asset to be purchased by the asset buyers; iteratively soliciting offers from the asset buyers to purchase the asset until a pre-determined criterion is met to end the transaction; awarding the asset to a winning asset buyer of the one or more asset buyers who offered a highest offer amount for the asset at the end of the transaction; dividing up the highest offer amount among the asset seller, asset creator and the one or more asset buyers according to a pre-determined allocation process, where the asset seller receives a first amount, the asset creator receives a second amount, and the one or more asset buyers receive one or more allocated asset buyer amounts; and creating a smart contract among the one or more asset buyers, where the smart contract defines one or more conditions for ownership of the asset.

### BACKGROUND

### Technical Field

The present invention relates, in general, to auctions, and, more particularly, but without limitation, to a bidding pool system using a blockchain.

Blockchain-based bidding systems are known in the art. In the past, a smart contract would only reward an artist or creator and not the bidders or the owners of a non-fungible token (“NFT”) based on the asset.

U.S. Pat. No. 10,839,379 discloses a Blockchain Including Linked Digital Assets.

U.S. Pat. No. 11,367,060 discloses a Collaborative Video Non-Fungible Tokens and Uses Thereof.

US 2019/0392511 discloses a Bid Matching for Blockchain-Based Goods/Assets Systems and Methods.

US 2020/0342539 discloses Systems, Methods, and Storage Media for Managing Digital Liquidity Tokens in a Distributed Ledger Platform.

US 2021/0174432 discloses a Computer Implemented Method and System for Updating a Database System for a Blockchain Version Control System: Computer Implemented Methods of Auctioning an Item for a Seller, and Computer Implemented Method of Updating a Smart Contract.

US 2022/0188781 discloses Systems and Methods for Efficient Electronic Token Ecosystems.

KR 102343025 discloses a Method of Trading Digital Art Based on Non-Fungible Token and Method of Trading Goods Using Thereof.

However, none of the art addresses a long-term system for rewarding bidders and owners via a blockchain. Therefore, there is a need for a system to reward bidders and owners of digital or physical assets in perpetuity through the blockchain.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A method for conducting a transaction between an asset seller, an asset creator and one or more asset buyers is disclosed. The method includes providing a marketplace for the transaction to be conducted; listing on a marketplace, by the asset seller, an asset to be purchased by the asset buyers; iteratively soliciting offers from the asset buyers to purchase the asset until a pre-determined criterion is met to end the transaction; awarding the asset to a winning asset buyer of the one or more asset buyers who offered a highest offer amount for the asset at the end of the transaction; dividing up the highest offer amount among the asset seller, asset creator and the one or more asset buyers according to a pre-determined allocation process, where the asset seller receives a first amount, the asset creator receives a second amount, and the one or more asset buyers receive one or more allocated asset buyer amounts; and creating a smart contract among the one or more asset buyers, where the smart contract defines one or more conditions for ownership of the asset

Other systems, methods, features, and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a view of a communications network for conducting a transaction between an asset seller, an asset creator and one or more asset buyers, according to the disclosure.

FIG. 2 is a flowchart illustrating acts for conducting a transaction between an asset seller, an asset creator and one or more asset buyers, according to the disclosure.

FIG. 3 is an example of a conduct of an auction process involving a bidders pool and a bidder buyers pool, according to the disclosure.

FIG. 4 is an example of conduct of an owner's pool transaction.

### DETAILED DESCRIPTION

The elements in the Figures interoperate as explained in more detail below. Before setting forth the detail explanation, however, it is noted that all of the discussion below, regardless of the particular implementation being described, is exemplary in nature, rather than limiting. For example, although selected aspects, features, or components of the implementations are depicted as being stored in memories, all or part of systems and methods consistent with the display systems may be stored on, distributed across, or read from other machine-readable media, for example, secondary storage devices such as hard disks, floppy disks, and CD-ROMs; a signal received from a network; or other forms of ROM or RAM either currently known or later developed.

Furthermore, although specific components of the architecture will be described, methods, systems, and articles of manufacture consistent with the architecture may include additional or different components. For example, a processor may be implemented as a microprocessor, microcontroller, application specific integrated circuit (ASIC), discrete logic, or a combination of other type of circuits or logic. Similarly, memories, may be DRAM, SRAM, Flash, or any other type of memory. Flags, data, databases, tables, and other data structures may be separately stored and managed, may be incorporated into a single memory or database, may be distributed, or may be logically and physically organized in many different ways. Programs may be parts of a single program, separate programs, or distributed across several memories and processors.

For the purposes of the disclosure, though describing an example definition and not a limiting definition, a “smart contract” may be a computer program, algorithm, sequence steps or a transaction protocol which is intended to automatically execute, control or document legally relevant events and actions according to the terms of a contract or an agreement.

For the purposes of the disclosure, though describing an example definition and not a limiting definition, a “blockchain” may be a type of digital ledger technology implemented in a computer program, storage medium containing instructions or a non-transitory signal and that consists of a growing list of records, called blocks, that are securely linked together using cryptography. Each block contains a cryptographic hash of the previous block, a timestamp, and transaction data (generally represented as a Merkle tree, where data nodes are represented by leafs). The timestamp proves that the transaction data existed when the block was created. Since each block contains information about the block previous to it, the blocks effectively form a chain, with each additional block linking to the ones before it. Blockchain transactions are intended to be irreversible in that, once they are recorded, the data in any given block cannot be altered retroactively without altering all subsequent blocks.

For the purposes of the disclosure, though describing an example definition and not a limiting definition, a “non-fungible token” or “NFT” is a non-fungible (uniquely identifiable and not interchangeable) financial security consisting of digital data stored in a blockchain. The ownership of an NFT is recorded in the blockchain, and can be transferred by the owner, allowing NFTs to be sold and traded. NFTs typically contain references to digital files such as photos, videos, and audio but can also be tied to physical items like houses or tangible goods of value tied to a digital asset.

The disclosure provides a bidder buyers pool to reward bidders and owners of digital or physical assets in perpetuity through the blockchain. A smart contract is created through acts implemented according to the disclosure, that takes a percentage, illustratively 5%, of an auction's asset sale price and splits that up among the bidders of an item whether it be digital (e.g., an NFT) or physical. The split may be determined by an algorithm that rewards bidders for higher bids. For example, the higher the bid above the previous bidder, the more the bidder will receive of the 5%.

After the initial auction and the creation of the smart contract, the method may change from the bidders pool to the bidder buyers pool. This may leave a certain amount, illustratively 1% of the 5% pool, for the bidders based on the set splits and illustratively 4%, for the actual owners of the NFT's starting with the first owner and adding every owner to this 4% based on the same algorithm rewarding owners for paying a higher price above the previous owner. This may reward both the bidders and the owners in perpetuity every time the asset changes hands.

For products that are listed with a set price, there is no bidders pool and only an owners' pool is enacted. Owners will get a percentage, illustratively 5%, commission to split, starting with the first owner and adding every subsequent owner to the smart contract after that based on the same algorithm rewarding the owners that pay a higher margin for the item.

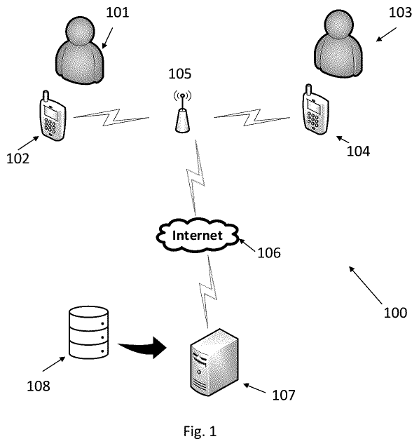

FIG. 1 is a view of a communications network for conducting a transaction between an asset seller, an asset creator and one or more asset buyers, according to the disclosure. FIG. 1 illustrates an example communications network 100 employed by users (101, 103) that supports the disclosed invention. In an aspect of the disclosure, the users (101, 103) may be parties interacting with the communications network 100 to participate in the transaction, such as asset sellers, asset creators and one or more asset buyers. The transaction parties may be seeking to sell or buy listed assets, such as physical assets such as homes or digital assets such as NFTs via an auction or fixed price sale transaction conduction over the communications network 100. The communications network 100 and thus the transaction among the parties may be distributed geographically and functionally, such that different parties and components of the communications network 100 may be located proximately or distantly from each other.

The communications network 100 may include a first user equipment (UE) 102 and a second UE 104. There may be multiple UEs representing one or more parties to the transaction connected to the communications network 100 and the UEs may be smart phones, laptops, tablet devices, smart watches, desktop computers, or other equipment that can connect in a wired or wireless manner. The communications network 100 may include a wired or wireless access point (AP) 105. The AP 105 may be a terrestrial wireless network such as a cellular communications network, WIFI network or other wireless connectivity systems. The AP 105 may be a satellite that supports ground-based communications. Examples of a wired communications network includes Ethernet, fiber, cable or other wired communications connectivity systems.

In an aspect of the disclosure, the AP 105 may connect to the Internet 106, as understood by one of skill in the art. The Internet 106 may include various routers and hubs (not shown).

In an embodiment of the disclosed invention, the Internet 106 may connect UEs 102, 104 to a server 107. The server 107 may contain processors, input units, memory, and output display units (not shown). The server 107 may support the functions of the disclosure. The server 107 may be multiple servers and the method of the disclosure may be implemented across multiple servers, the UEs (102, 104) or other processing devices as needed. The server 107 may also include a cloud-based collection of one or more servers distributed in different locations and/or or making use of cloud-based applications to implement the disclosure.

In an embodiment, the server 107 may be located in local proximity to the UEs (102, 104) such that the UEs (102, 104) do not access the Internet 106 to make use of the disclosed invention.

In an aspect of the disclosure, the server 107 may interface with a database 108. The database 108 may information and records related to the transaction, such as party information, asset information, prices, schedules, the blockchain, smart contract implementation and other information and data related to the transaction. The database 108 may be a distributed database, such that the database 108 may be referenced and/or accessed as more than one database 108 located proximate or connected to the server 107 or distributed across a network such the Internet 106 or other communications network, such as an intranet, mesh network, personal area network such as a Bluetooth network or a wide area network.

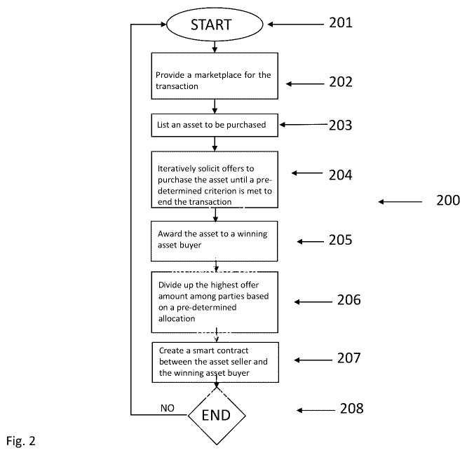

FIG. 2 is flowchart illustrating acts for conducting a transaction between an asset seller, an asset creator and one or more asset buyers in a communications network 100, according to the disclosure. The communication network 100 may be established and provided in an act 201.

In an act 202 according to the disclosure, a marketplace may be for the transaction to be conducted. The marketplace may be configured to execute on the communications network 100 such as run from a server 107 as an executable program, a graphical user interface, interactive communications system, text, SMS, verbal, audiovisual or other means of providing a virtual marketplace or financial exchange for asset auctions and sales to take place. In an aspect, the marketplace may also include banks, clearinghouses, escrow accounts or other financial institutions and systems to effectuate the transaction.

In an act 203 according to the disclosure, an asset seller may list on the marketplace, an asset to be purchased by the asset buyers. The asset may be a physical asset in many forms, or may be a digital asset. In an aspect of the disclosure, the digital asset may be an NFT.

In an act 204, the method may iteratively solicit offers from the asset buyers to purchase the asset until a pre-determined criterion is met to end the transaction. The pre-determined criterion may be a time period, a floor or limit value associated with the asset or other criteria that the asset seller requires or desires as a condition for completing the transaction. Asset buyers may be allowed to make multiple bids during the period or condition when bids are solicited. In an aspect, only a certain specified number of bids may be allowed.

In an act 205, the method awards the asset to a winning asset buyer of the one or more asset buyers who offered a highest offer amount for the asset at the end of the transaction.

In an act 206, the method divides up the highest offer amount among the asset seller, asset creator and the one or more asset buyers according to a pre-determined allocation process, where the asset seller receives a first amount, the asset creator receives a second amount, and the one or more asset buyers receive one or more allocated asset buyer amounts.

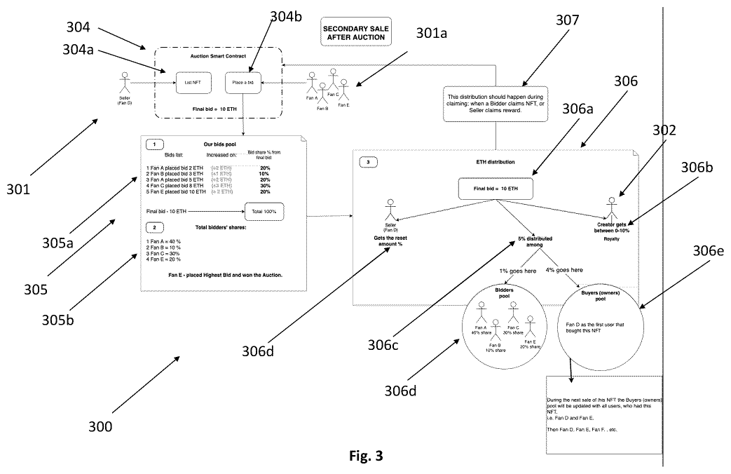

For an auction process, as an illustrative but not limiting example, the allocation percentages for each of the one or more asset buyers are calculated. These allocation percentages may determine what portion of the final selling price of the asset are received by each asset buyer. In an example illustrated in FIG. 3, one bidder's share is 40%, a second bidder's share is 10%, a third bidder's share is 30% and a fourth's bidder share is 20%.

In an aspect of the disclosure shown in FIG. 3, the final bid for the asset is 10 ETH, which is the value used to calculate the distribution to the parties. In this example, the asset creator may receive 0-10% of the final bid price of 10 ETH. The allocation value is pre-determined as part of the smart contract and auction process implementation. Other allocation values may be possible.

An allocation of 5% of the final bid prices is distributed among the bidders pool (made up of the bidders participating in the auction process) and the buyers (owners) pool (made up of the asset owner initially, as the first user that bought the NFT that was auctioned). In this example, in the bidders pool, the first bidder gets 40% of the 1% of the final bid price based on the auction process outcome; the second bidder gets 10% of the 1% final bid price; the third bidder gets a 30% share of the 1% final bid price; and the fourth bidder gets a 20% share of the 1% final bid price. In the buyers (owners) pool, the asset seller receives 4% of the final bid price.

The asset seller receives the remainder of the final bid price after subtracting out the asset creator allocation and the 5% distribution among the bidders pool and buyers (owners) pool.

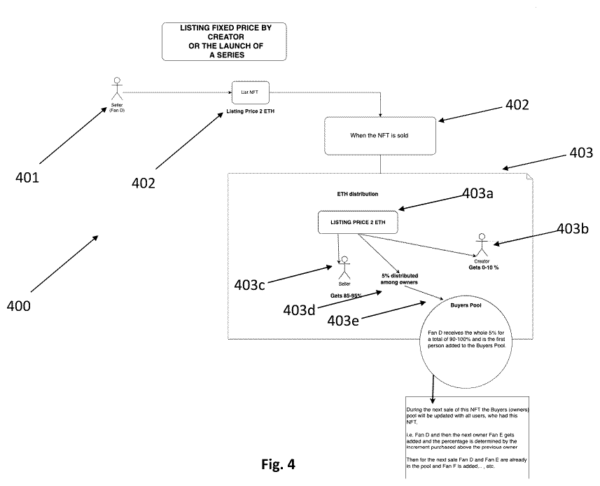

In an alternative transaction process illustrated in FIG. 4, the asset is listed with a fixed listing price. When a prevailing asset buyer offers up the fixed listing price, the fixed listing price distribution occurs. The listing price in this example is 2 ETH shown in FIG. 4. The asset creator may receive an allocation of 0-10% of the fixed listing price based on a pre-determined allocation formula and the details of the smart contract. The asset seller receives 85-95% of the fixed listing price, based on the pre-determined allocation formula. In addition, the asset seller is entered into the buyers pool and receives the entire 5% distribution among the owners in this stage of the asset ownership and transaction details related to the smart contract. The asset seller is the first person added to the buyers pool. During the next sale of the NFT, the buyers (owners) pool will be updated with all users who owned this NFT historically. For example, here the asset seller is added to the buyers (owners) pool. Then the next owner is added in subsequent sales of the NFT, and the percentage allocation is determined by the increment purchased above the previous owner's purchase price. Subsequently, for the next sale, the initial asset owner and the subsequent owner are in the buyers (owners) pool and a third new asset buyer may be added. This is repeated through the duration of the existence and sales of the NFT, and recorded on the blockchain associated with the transaction

In an act 207, the method creates a smart contract among the one or more asset buyers, where the smart contract defines one or more conditions for ownership of the asset. The smart contract may define the allocations for distribution of the final bidding price, the addition of parties to the buyers (owners) pool for future transactions and other details related to the economic/financial parameters of the transaction completion and related legal and logistical requirements for completing the transaction and recording the smart contract on the blockchain.

In an act 208, the method may terminate or may repeat, where the asset seller and the winning asset buyer sell the asset again after one or more previous sales of the asset. The initial asset seller and the winning asset buyer from the first and succeeding rounds are added to the auction pool in an iterative and continuing process in perpetuity. In an aspect, creating the smart contract includes storing the smart contract on a blockchain. The blockchain may be implemented and stored in a distributed communications network 100, stored and accessed on a distributed database 108 or other implementations of a blockchain ledger as known to one of skill in the art. The smart contract may be stored as a record, entry or component of a ledger on the blockchain. The smart contract may include and record the one or more previous sales of the asset as an entry on the blockchain. As iterative and future sales of the asset proceed, the records of the transactions associated with the asset are recorded, along with records of the initial seller and successive prevailing buyers from the transactions. Thus, the smart contract includes adding the asset seller and the winning asset buyer as asset owners as an entry on the blockchain.

In an aspect of the disclosure, the asset may be listed for the transaction on the marketplace with a set or fixed price. In this aspect, dividing up the highest offer, in this instance, the listed price, received for the fixed price asset includes dividing up the highest offer (i.e., the fixed price) between the asset seller, the asset creator and the winning asset buyer according to a pre-determined allocation algorithm, and then recorded as a smart contract on the blockchain associated with the asset.

FIG. 3 is an example of a conduct of an auction process 300 involving a bidders pool and a bidder buyers pool, according to the disclosure. In the auction process 300, there may be an asset seller 301 who desires to sell an asset, such as a physical or digital asset. In an aspect of the disclosure, the asset may be an NFT. There may be one or more asset buyers 301a participating in the auction process 300, and may be interested in purchasing the asset that is listed on a marketplace by the asset seller 301. An asset creator 302 may also participate in the auction process 300, and may receive certain proceeds from the results of the transaction, as described herein.

At the outset of the current transaction, in this aspect an auction, a smart-contract based auction 304 will be set up. The asset seller 301 may list an asset such as an NFT via a marketplace action 304a. The listing 304a may include details about the asset, such as price, description, location (e.g., URL or website or other repository of a digital asset) and other information related to a sale of the asset. After the asset is listed 304a, the transaction, the auction 304 may begin. One or more asset buyers 301a may place a bid 304b for the asset. The one or more buyers 301a may place bids simultaneously, in sequence or other pre-determined order of bid conduct prescribed by the marketplace and the details of the smart contract based auction 304. In this example shown in FIG. 3, a final bid of 10 ETH (Ethereum bitcoin units) occurred for the purchase of the asset. A smart contract is then formed between the seller 301 and the prevailing asset buyer, who is one of the one or more asset buyers 301a.

The details of the bidding action are shown in exemplary detail in the bidding stage 305. In the bidding stage 305, one or more bids may be placed 305a by the one or more buyers 301a. In this example, there are four asset buyers 301a (Fan A, Fan B, Fan C and Fan E). Fan D is labeled for the asset seller 30. As illustrated in the bidding sequence 305a, Fan A places a first bid of 2 ETH, which represents an increase of +2 ETH on the current bid price. The bid share percentage relative to the final bid is calculated when the transaction is completed, but here the example calculation is shown as 20% based on the 10 ETH final bid described in the auction process 304. Successive bids are made in this example, where Fan B makes the next bid of 3 ETH for the asset, resulting in a +1 ETH change over the previous bid, and a bid share percentage of 10%. Fan A next places a bid of 5 ETH, an increase of +2 ETH over the previous bid, and resulting in a 20% bid share percentage. Fan C places a bid of 8 ETH, an increase of +3 ETH over the previous bid and a bid share percentage of 30%. Finally, Fan E places a bid of 10 ETH, an increase of +2 ETH and a bid share percentage of 20%. Fan E's bid of 10 ETH is the final and highest bid. Fan E has won the auction and the asset is awarded to Fan E. In stage two of the bidding process, the bidders pool allocation percentages for each fan are calculated. These allocation percentages may determine what portion of the final selling price of the asset are received by each asset buyer. In this example 305b, Fan A's bidder share is 40%, Fan B's bidder share is 10%, Fan C's bidder share is 30% and Fan E's bidder share is 20%.

In an aspect of the disclosure shown in FIG. 3, the asset price distribution is conducted in an ETH Distribution phase 306. As described above, the final bid for the asset is 10 ETH 306a, which is the value used to calculate the distribution to the parties. In this example, the asset creator 302 may receive 0-10% of the final bid price of 10 ETH. The allocation value is pre-determined as part of the smart contract and auction process implementation. Other allocation values may be possible.

An allocation of 5% 306c of the final bid prices is distributed among the bidders pool 306d (made up of Fan A, Fan B, Fan C and Fan E) and the buyers (owners) pool 306e (made up of Fan D initially, as the first user that bought the NFT that was auctioned). In this example, in the bidders pool 306d, Fan A gets 40% of the 1% of the final bid price based on the auction process outcome; Fan B gets 10% of the 1% final bid price; Fan C gets a 30% share of the 1% final bid price; and Fan E gets a 20% share of the 1% final bid price. In the buyers (owners) pool 306e, Fan D receives 4% of the final bid price.

The asset seller (Fan D) receives the remainder of the final bid price after subtracting out the asset creator allocation and the 5% distribution among the bidders pool 306d and buyers (owners) pool 306e.

During the next sale of the NFT, should it occur, the buyers (owners) pool 306e will be updated with all users who owned this NFT. For example, the next round buyers (owners) pool would have Fan D and Fan E in the buyers (owners) pool 306e. The auction process can be repeated iteratively with the actions shown in FIG. 3 and allocation amounts illustrated therein.

FIG. 4 is an example of conduct of an owner's pool transaction 400. In this example, the asset has a listing fixed price by the asset creator 403b or a launch of a series of NFTs. In this example, the asset seller 401 (Fan D) may list the asset, such as a physical asset or digital asset such as an NFT, on a marketplace listing 402. In this example, the listing is a fixed listing price of 2 ETH. An auction will not occur in this example 400. When an asset buyer offers up the fixed listing price 402, the fixed listing price distribution occurs 403. The listing price in this example is 2 ETH 403a. The asset creator 403b may receive an allocation of 0-10% of the fixed listing price based on a pre-determined allocation formula and the details of the smart contract. The asset seller (Fan D) receives 85-95% of the fixed listing price, based on the pre-determined allocation formula. In addition, the asset seller (Fan D) is entered into the buyers pool 403e and receives the entire 5% distribution among the owners in this stage of the asset ownership and transaction details related to the smart contract. Asset seller 401 (Fan D) is the first person added to the buyers pool. During the next sale of the NFT, the buyers (owners) pool will be updated with all users who owned this NFT historically. For example, here Fan D is added to the buyers (owners) pool 403e. Then the next owner, such as a Fan E gets added in subsequent sales of the NFT, and the percentage allocation is determined by the increment purchased above the previous owner's purchase price. Subsequently, for the next sale, Fan D and Fan E are in the buyers (owners) pool and a Fan F may be added. This is repeated through the duration of the existence and sales of the NFT and recorded on the blockchain associated with the transaction.

The sequence diagram in FIG. 2 and the acts shown in FIGS. 3 and 4 may be encoded in a signal bearing medium, a computer readable medium such as a memory, programmed within a device such as one or more integrated circuits, or processed by a controller or a computer. If the methods are performed by software, the software may reside in a memory resident to or interfaced to the any type of non-volatile or volatile memory interfaced or resident to the memory incorporated in the components in the communications network (100). Such memory may include an ordered listing of executable instructions for implementing logical functions. A logical function may be implemented through digital circuitry, through source code, through Smart Contract, through analog circuitry, or through an analog source such through an analog electrical, audio, or video signal. The software may be embodied in any computer-readable or signal-bearing medium, for use by, or in connection with an instruction executable system, apparatus, or device. Such a system may include a computer-based system, a processor-containing system, or another system that may selectively fetch instructions from an instruction executable system, apparatus, or device that may also execute instructions.

A “computer-readable medium,” “machine-readable medium,” “propagated-signal” medium, and/or “signal-bearing medium” may comprise any means that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical connection “electronic” having one or more wires, a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical). A machine-readable medium may also include a tangible medium upon which software is printed, as the software may be electronically stored as an image or in another format (e.g., through an optical scan), then compiled, and/or interpreted or otherwise processed. The processed medium may then be stored in a computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method for conducting a transaction between an asset seller, an asset creator and one or more asset buyers, the method comprising:
providing a smart contract to transact through a marketplace for the transaction to be conducted;
listing on a marketplace, by the asset seller, an asset to be purchased by the asset buyers;
iteratively soliciting offers from the asset buyers to purchase the asset until a pre-determined criterion is met to end the transaction;
awarding the asset to a winning asset buyer of the one or more asset buyers who offered a highest offer amount for the asset at the end of the transaction;
dividing up the highest offer amount among the asset seller, asset creator and the one or more asset buyers according to a pre-determined allocation process, where the asset seller receives a first amount, the asset creator receives a second amount, and the one or more asset buyers receive one or more allocated asset buyer amounts; and
creating a smart contract among the asset seller and the winning asset buyer, where the smart contract defines one or more conditions for ownership of the asset.

2. The method of claim 1, where the asset seller and the winning asset buyer sell the asset again after one or more previous sales of the asset.

3. The method of claim 1, where the asset is a non-fungible token.

4. The method of claim 2, where creating the smart contract comprises storing the smart contract on a blockchain.

5. The method of claim 4, where creating the smart contract comprises recording the one or more previous sales of the asset as an entry on the blockchain.

6. The method of claim 4, where creating the smart contract comprises adding the asset seller and the winning asset buyer as asset owners as an entry on the blockchain.

7. The method of claim 1, where the transaction comprises an auction.

8. The method of claim 1, where listing on the marketplace comprises listing a fixed price for the asset.

9. The method of claim 8, where dividing up the highest offer comprises dividing up the highest offer between the asset seller, the asset creator and the winning asset buyer.

10. The method of claim 1, where the asset is a physical asset or a digital asset.

11. The method of claim 1, where providing the marketplace for the transaction to be conducted comprises providing a distributed network for the asset seller, the asset creator and the one or more asset buyers to conduct the transaction.

12. An apparatus for conducting a transaction between an asset seller, an asset creator and one or more asset buyers, the apparatus comprising:
a memory configured to store instructions;
a processor configured to execute the instructions stored in the memory, the instructions comprising instructions to:
provide a marketplace for the transaction to be conducted;
list on a marketplace, by the asset seller, an asset to be purchased by the asset buyers;
iteratively solicit offers from the asset buyers to purchase the asset until a pre-determined criterion is met to end the transaction;
award the asset to a winning asset buyer of the one or more asset buyers who offered a highest offer amount for the asset at the end of the transaction;
divide up the highest offer amount among the asset seller, asset creator and the one or more asset buyers according to a pre-determined allocation process, where the asset seller receives a first amount, the asset creator receives a second amount, and the one or more asset buyers receive one or more allocated asset buyer amounts; and
create a smart contract among the one or more asset buyers, where the smart contract defines one or more conditions for ownership of the asset.

13. The apparatus of claim 12, where the asset seller and the winning asset buyer sell the asset again after one or more previous sales of the asset.

14. The apparatus of claim 12, where the asset is a non-fungible token.

15. The apparatus of claim 13, where the instructions to create the smart contract comprise instructions to store the smart contract on a blockchain.

16. The apparatus of claim 15, where the instructions to create the smart contract comprise instructions to record the one or more previous sales of the asset as an entry on the blockchain.

17. The apparatus of claim 15, where the instructions to create the smart contract comprise instructions to add the asset seller and the winning asset buyer as asset owners as an entry on the blockchain.

18. The apparatus of claim 12, where the transaction comprises an auction.

19. The method of claim 12, where listing on the marketplace comprises listing a fixed price for the asset.

20. The method of claim 19, where dividing up the highest offer comprises dividing up the highest offer between the asset seller, the asset creator and the winning asset buyer.
